(19) United States
(12) Patent Application Publication
(10) Pub. No.: US 2006/0198369 A1
(43) Pub. Date: Sep. 7, 2006

(54) Lookup table circuit structure for network switch device

(76) Inventors: Chueh-min Huang, Hsin-chu City (TW); Kuo-chung Gan, Hsin-chu City (TW)

Correspondence Address: LIN & ASSOCIATES INTELLECTUAL PROPERTY, P.O. BOX 2339, SARATOGA, CA, 95070-0339, US

(21) Appl. No.: 11/075,062

(22) Filed: Mar. 5, 2005

(51) Int. Cl. H04L 12/56; H04L 12/28

(52) U.S. Cl. 370/389

(57) ABSTRACT

A circuit structure for implementing the lookup table of a network switching device is provided. With the circuit structure, the memory space of the lookup table could be fully utilized, and the time spent in searching the table is guaranteed to be within a specific time interval. The circuit structure divides the memory space of the lookup table into N blocks, each of which contains L records. The N blocks are directly connected to all search and comparison engines of the M network ports via separate buses respectively. An address generator continuously issues sequential address signals 0, 1, 2 . . . , L−1 to all blocks. Upon receiving an address signal, each block delivers its addressed record to all search and comparison engines via its own bus. A search and comparison engine therefore would compare all N×L records of the lookup table after the address generator has finished a full cycle of issuing L addresses. Searching the lookup table for an incoming packet, in the worst case, wouldn't take up more time than what is required by the address generator to issue a full cycle of L addresses.

### BACKGROUND OF THE INVENTION

1. Field of the Invention

The present invention generally relates to network switch devices, and more particularly to a circuit structure for storing and searching a lookup table of network switch devices.

2. The Prior Arts

For wired and wireless local area networks (LANs), as there are theoretical and practical limitations on the radio coverage and cable length, it is the LAN switches that interconnect separate wired and wireless LAN segments into a complete network.

As the technology advances, the LAN switches now commonly support a large number of network ports, provide additional transmission interfaces and media such as fiber and wireless, and even offer more advanced packet processing (such as the load balancing function found in layer-3 switches). However, the most basic function of all LAN switches still lies in the so-called packet forwarding.

FIG. 1 is a schematic diagram showing the structure of a typical LAN. As illustrated, the LAN switch 10 has its network ports 0, 2, and 5 connected to three LAN segments 20, 30, and 40 respectively. As the computing devices on the three LAN segments start to communicate and exchange information between each other, the hardware or built-in firmware of the LAN switch 10 establishes a lookup table based on the source addresses (i.e., the layer 2 or MAC addresses) contained in the packets issued from these computing devices. This lookup table (not shown in FIG. 1) records the MAC address of every computing device within this local area network, the network port to which the computing device's LAN segment is connected, and perhaps other relevant information (such as the layer 3 or IP address).

Using FIG. 1 as an example, if the computing device 21 is sending information to the computing device 31, the LAN switch 10 would receive packets issued from the computing device 21 coming in from the network port 0 (i.e., the LAN segment 20) and designating the computing device 31 as destination. By examining the lookup table, the LAN switch 10 is able to know that the computing device 31 is located on a LAN segment (i.e., the LAN segment 30), which is connected to the network port 2. The LAN switch 10 thereby forwards these packets via the network port 2 to the LAN segment 30 (instead of the LAN segments 20 and 40). Similarly, if the computing device 21 is sending information to the computing device 22, the LAN switch 10 would receive packets issued from the computing device 21 coming in from the network port 0 (i.e., the LAN segment 20) and designating the computing device 22 as destination. By examining the lookup table, the LAN switch 10 is able to know that the computing device 22 is located on a LAN segment (i.e., the LAN segment 20), which is connected to the same network port 0 from which these packets are issued. The LAN switch 10 thereby drops these packets (instead of forwarding them) as it knows that the computing device 22 would receive these packets as well. In this way, the LAN switch 10 prevents unnecessary packets from entering the LAN segments 20, 30, and 40, and causing network performance degradation. Please note that the packet forwarding operation has a time constraint. The LAN switch 10 must complete the forwarding or dropping a packet received from a network port before a next packet coming into the same network port. If the LAN switch 10 fails to do that, there are two possible outcomes based on how the LAN switch 10 is implemented. One outcome is that, since the processing of the current packet is not done yet, the LAN switch 10's diversion to the new packet would cause the current packet to be lost. The other outcome is that, as the LAN switch 10 continues its processing of the current packet, the new packet would be lost. In either way, such packet loss under the conventional communications protocols would cause the sending computing device to re-send the lost packet after a period of time. These resent packets consume network bandwidth; the delay in resending packets also slows down the network transmission. As can be imagined, if such packet collision happens quite often, the LAN performance would be significantly degraded.

As the LAN switch's number of network ports and the computing devices connected to the LAN increase, and as the network transmission speed increases from 10 Mbits/sec and 100 Mbits/sec to even up to 10 Gbits/sec, even the most basic forwarding function of the LAN switch is facing serious challenge. As the number of connected computing devices increases, the lookup table would contain more content, and searching the lookup table would inevitably take longer time. On the other hand, as the network transmission speed increases, the LAN switch has even less time to complete the processing of the packets. How to effectively search the lookup table has therefore become an important topic in the networking industries.

Three types of table search are commonly used in conventional LAN switches. For linear search, as the name implies, the records of the lookup table are arranged in a specific order and, to search the table, the records are examined one by one following the order until a record whose MAC address matches a packet's destination MAC address is found. Linear search is a very simple method and the memory space reserved for the lookup table could be fully utilized. Linear search is usually implemented in firmware. To speed up the search, high performance hardware components are usually required and, therefore, the implementation cost is increased.

Another commonly used search method is hashing, which uses a special hashing function to translate the MAC address into a record address of the lookup table. To store a computing device's information in the lookup table, the hashing function is used to determine which record to use based on the computing device's MAC address. Similarly, when a packet is received, the same hashing function is used to determine which record contains the information about the packet's targeted computing device. For both storing and searching the lookup table, hashing requires only a single calculation and, as hashing often is implemented in hardware, the search speed is very fast. However, the so-called hashing collision is almost inevitable that different MAC addresses are mapped to the same record address by the hashing function. Due to hashing collision, some of the memory space reserved for the lookup table is never used. Further more, hashing collision adds an uncertainty factor to searching the lookup table, as an indefinite number of device information is associated to the same record address. The third method is called content addressable memory (CAM). CAM is similar to hashing as some content of a packet is mapped to a unique record address of the lookup table. CAM utilizes a complicated hardware addressing mechanism to avoid collisions. CAM therefore enjoys both benefits of fast searching and fully utilized memory space. However, these benefits do come with a price. CAM is the most costly approach, compared to hashing and linear search.

### SUMMARY OF THE INVENTION

Accordingly, in order to obviate the shortcomings of conventional search methods, the present invention provides a circuit structure for a LAN switch's lookup table. The circuit structure not only could fully utilize the memory space of the lookup table, but also could avoid packet collisions by guaranteeing every search to the lookup table is always finished within a specific time limit.

The major spirit of the present invention is not in pursuing the shortest search time, but in achieving the predictability in searching the lookup table. The present invention utilizes a massive parallel circuit structure to guarantees that, even in the worst case, the search time is always under a specific time limit. Based on the proposed structure and careful design, the present invention could adopt the most cost effective hardware components. Compared to prior arts which have to adopt unnecessarily high performance hardware components due to the uncertainty in searching the lookup table, this is one of the major improvements of the present invention over prior arts, and the LAN switches based on the present invention would usually have a reasonable cost.

Another objective of the present invention is to provide a circuit structure whose searching operation could be implemented in hardware (instead of only in firmware). This could further speed up the table search, reduce the cost, and cut down the workload of other components.

The circuit structure of the present invention partitions the lookup table's memory space into N (N≧1) blocks, each of which contains L (L≧1) records (i.e., there are totally N×L records in the lookup table). The LAN switch has M network ports, each of which is associated with a search/comparison device. Each of the N blocks is connected to all M search/comparison devices via a separate bus respectively (i.e., there are totally N buses between the N blocks and the M search/comparison devices). In other words, a record in one of the N blocks could be delivered simultaneously to all M search/comparison devices in parallel. A search/comparison device, on the other hand, could receive N records simultaneously from the N blocks.

The circuit structure of the present invention further contains an addressing device which, after being triggered by a search/comparison device, would generate sequential address signals 0, 1, . . . , L−1 to all N blocks. Once receiving an address signal, each of the N blocks would deliver its addressed record via its own bus to all M search/comparison devices in parallel. In other words, each of the M search/comparison devices would receive first the N records at address 0 from all N blocks, then another N records at address 1 from all N blocks, and so on. After the addressing device finishes generating the L addresses, each of the M search/comparison devices would receive all N×L records in the lookup table. Therefore, in the worst case, the present invention could finish searching the lookup table no longer than the time required by the addressing device to generate a full cycle of L addresses.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a schematic diagram showing the structure of a typical LAN.

FIG. 2 is a schematic diagram showing a preferred embodiment of the present invention applied in a layer 2 LAN switch.

FIGS. 3a and 3b are schematic diagrams showing two time sequences of the addressing device according to a preferred embodiment of the present invention.

FIG. 4 is a schematic diagram showing the record structure of the lookup table according to a preferred embodiment of the present invention.

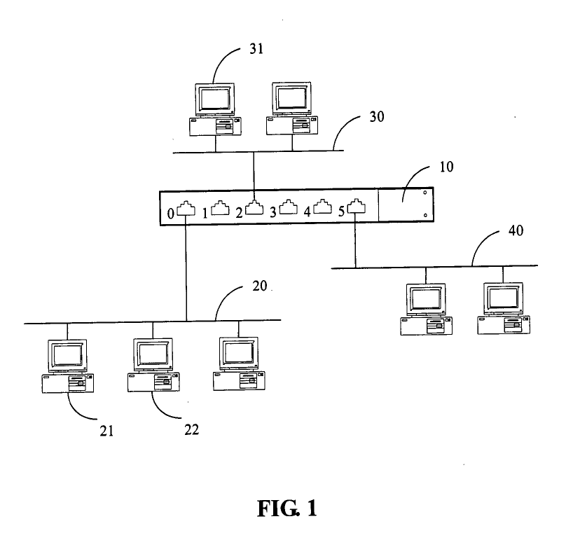

### DETAILED DESCRIPTION OF THE PREFERRED EMBODIMENTS

In the following, detailed description along with the accompanied drawings is given to better explain preferred embodiments of the present invention. Please be noted that, in the accompanied drawings, some parts are not drawn to scale or are somewhat exaggerated, so that people skilled in the art can better understand the principles of the present invention.

The circuit structure provided by the present invention could be applied to the storage and searching of records in a lookup table of a layer 2 or above network switch device. The network switch device here refers to common layer 2 LAN switches, and those switches, routers, or similar devices providing higher level switching functions. The greatest feature of these network switch devices lies in that they all have multiple network ports, and they are required to decide whether to discard a packet received from one of its network ports, or to forward it out through another network port. To do this job, these devices usually have to keep track of the network port to which a computing device's located network segment is connected in a lookup table.

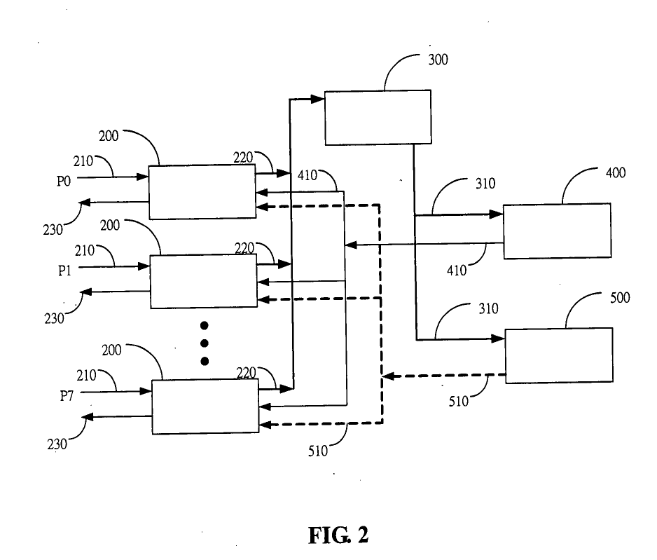

FIG. 2 is a schematic diagram showing a preferred embodiment of the present invention applied in a layer 2 LAN switch. As will be described below, the operations of these functional blocks could be completely implemented in hardware, or in partially hardware and partially firmware, or in firmware completely. In the present embodiment, the layer 2 MAC address is mainly used as the base for search. However, please note that the present invention could be utilized in other types of network switch devices using addresses other than the MAC address for packet routing decisions.

What are depicted in FIG. 2 are those in a layer 2 LAN switch related to the present invention. The other modules or components are pretty much identical to those found in a typical layer 2 LAN switch and, therefore, their details are omitted here for simplicity sake. For those skilled in the related art, such omission shouldn't obstruct their understanding of the spirit of the present invention. As illustrated, the LAN switch has eight network ports (numbered from P0-P7). Within the LAN switch, the interface circuits (not shown) of the eight network ports (P0-P7) are connected to eight corresponding search/comparison devices 200 respectively. Whenever a network port receives a packet, the packet is passed to the corresponding search/comparison device 200 via a connection 210. Please note that the network ports (P0-P7) and their corresponding search/comparison devices 200 function independently and in parallel. In other words, for example, while the network port P2 is receiving a packet, the network port P5 is processing another packet simultaneously.

The search/comparison device 200, after receiving a packet, would extract important information from the packet, such as the MAC address of the computing device sending this packet (i.e., the source address) and the MAC address of the computing device where the packet is targeted (i.e., the destination address). The search/comparison device 200 then issues a search signal via the bus 220 to an addressing device 300. Please note that, as the search/comparison devices 200 operate in parallel, the addressing device 300 could receive multiple search signals issued from more than one search/comparison device 200 simultaneously. An arbitration mechanism (not shown) of the bus 220 would resolve the conflict.

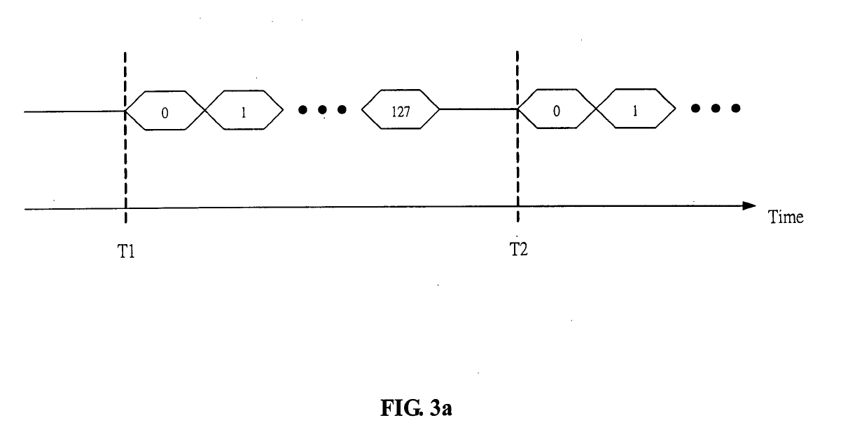

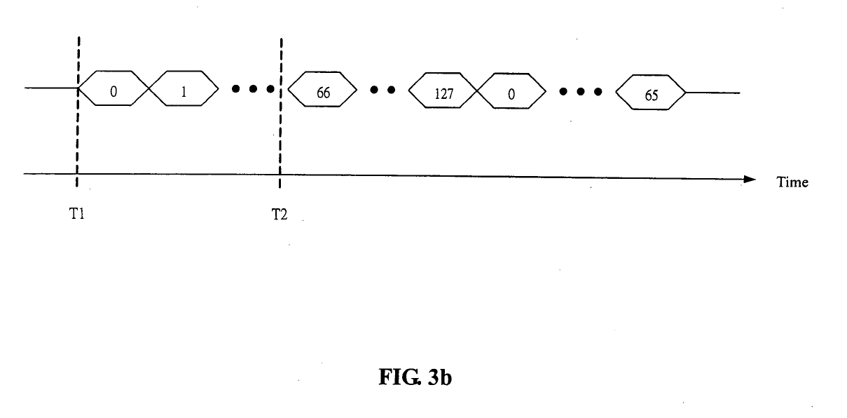

Upon receiving a search signal, the address device 300 would start to generate sequential address signals and output them to the bus 310. In the present embodiment, the addressing device would generate sequentially and totally 128 address signals from address 0, address 1 . . . to address 127. As shown in FIG. 3a, which is a time sequence diagram of the bus 310, the addressing device 300 receives a search signal from network port P0's search/comparison device 200 at time T1. The addressing device 300 then sequentially generates the 128 address signals. After that, at time T2, another search signal from the network port P1's search/comparison device 200 arrives and the addressing device, again, generates another cycle of 128 sequential address signals. Another possible scenario is depicted in FIG. 3b. As illustrated, the addressing device 300 receives a search signal from network port P0's search/comparison device 200 at time T1. The addressing device 300 then sequentially generates the 128 address signals. Then, at time T2 when the addressing device 300 is issuing the address signal 65, another search signal from the network port P1's search/comparison device 200 arrives. The addressing device 300 records down the address (i.e., 65) issued at that time, and continues to generate the subsequent addresses of the current cycle. After finishing the current cycle, the addressing device continues to generate address signals from 0 and stops at the earlier recorded address 65. As far as the network port P1 is concerned, the addressing device 300 also generate full 128 sequential addresses for its search/comparison device 200, except that the issued addresses start from 66 to 127, and then from 0 to 65 (instead of from 0 to 127).

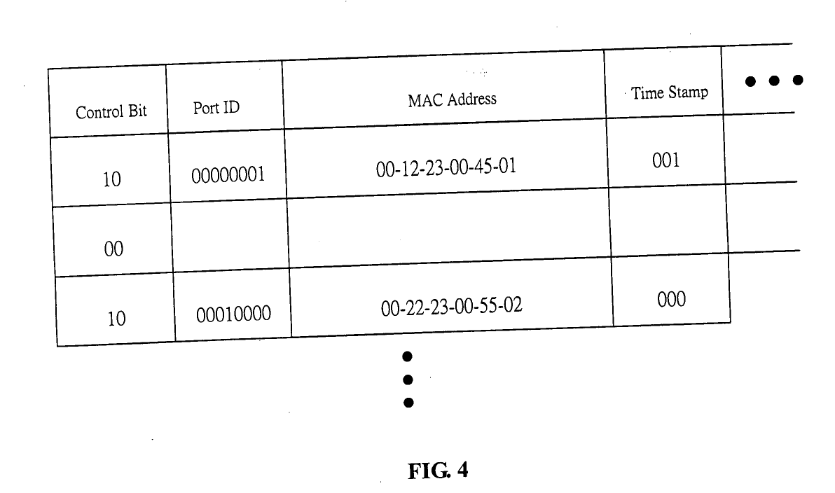

In the present embodiment, the memory space for the lookup table is partitioned into two blocks 400 and 500. Each block could hold up to 128 records and therefore there are totally 128×2=256 records in the lookup table. Each record contains multiple fields and each field contains one or more bits, as shown in FIG. 4. Among these fields, the control bit field is used to indicate whether this is a valid record. A valid record means this record contains information about a computing device; an invalid record means this record is empty (i.e., not used). The control bit field also indicates whether this record is a constantly resident record (i.e., whether the information contained in this record stays in the lookup table forever). The port ID field records the port to which the computing device's residential network segment is connected. The MAC address field records the MAC address of the computing device. The time stamp field, on the other hand, shows how long the information contained in the record has been stayed but not accessed inside the lookup table. When a valid record has not been accessed for a long time, this could mean that the corresponding computing device is crashed, shut down, or disconnected from the LAN. The network switch device could update the record's control bit field to indicate that this is an empty record so as to release the space to hold information about other computing devices.

Please refer to FIG. 2 again. The address bus 310 of the addressing device 300 feeds the address signals simultaneously to the blocks 400 and 500 in parallel. The blocks 400 and 500 would therefore receive identical address signals at the same time. When receiving an address signal, the blocks 400 and 500 would in parallel retrieves the content of their corresponding addressed records, and output them to their separate output buses 410 and 510 respectively. The output buses 410 and 510 are connected to the eight search/comparison devices 200 simultaneously. Accordingly, the eight search/comparison devices 200 would receive two records simultaneously and in parallel, one from the block 400 and the other one from the block 500.

Using the time sequence depicted in FIG. 3a as an example, when the search/comparison device 200 of network port P0 receives a packet and would like to decide how to process the packet, the search/comparison device 200 of network port P0 issues a search signal to the addressing device 300 at time T1. The addressing device 300 therefore starts to sequentially generate 0-127 address signals to the blocks 400 and 500. Then, the search/comparison device 200 of network port P0 would begin to receive simultaneously record 0 of the block 400 and record 0 of the block 500, and then receive simultaneously record 1 of the block 400 and record 1 of the block 500, and so on, until record 127 of the block 400 and record 127 of the block 500. Whenever receiving a batch of records from the blocks, the search/comparison device 200 would conduct two comparisons. One is to compare the packet's source address to the records' MAC address field. If no match is found after 128 rounds of comparisons, this could mean a new computing device has joined the LAN and the search/comparison device 200 notify the other modules (not shown) of the LAN switch via connection 230 to add a record in the lookup table. Another comparison is to compare the packet's destination address to the records' MAC address field. If a record having a matched MAC address is found, the record's port ID field is further compared to the packet's incoming port (i.e., where the packet is received from). If the comparison indicates that the packet is destined to a computing device located on the same network segment, the search/comparison device 200 would notify the other modules of the LAN switch to discard the packet. Otherwise, the search/comparison device 200 would notify the other modules of the LAN switch to forward the packet to the network segment specified by the port ID field of the found record.

In this example, please note that, even though it is the search/comparison device 200 of the network port P0 activates the addressing device 300 to generate address signals, the search/comparison devices 200 of all other network ports would also receive the records output from the blocks 400 and 500 in parallel. It is just that these network ports do not have any incoming packet and therefore no comparison is conducted. However, if the scenario is as depicted in FIG. 3b, while the search/comparison device 200 is conducting its comparison, the search/comparison device 200 of network port P1 receives a packet and issues a search signal to the addressing device 300 as well. The search/comparison device 200 of network port P1 then starts to conduct comparisons against the records output from the blocks 400 and 500, similar to the search/comparison device 200 of network port P0. The only difference is that the search/comparison device 200 of network port P1 starts the comparison from address 66, instead of address 0.

For every search/comparison device 200, as long as it issues a search signal to the addressing device 300, it starts to collect the records output from the blocks 400 and 500, and conducts the aforementioned source address and destination address comparisons against the collected records. In the worst case, the search/comparison device 200 would repeat such collection and comparison operations up to 128 times. After a full cycle of 128 collection and comparison operations, the search/comparison device 200 would certainly be able to make a decision about (1) whether to record the packet's source address in the lookup table, and (2) whether to discard or forward the packet. Therefore, for a network switch device according to the present embodiment, its hardware could be precisely designed so as to complete a full cycle of 128 collection and comparison operations before a specific time limit. The packet collision problem is thereby avoided effectively and economically.

For every search/comparison device 200, if it could reach a decision before the full cycle of 128 collection and comparison operations, it could notify the other modules of the LAN switch to carry out the relevant action immediately. For example, if a search/comparison device 200 finds a record matching the packet's destination address when it is comparing all records of address 65 from all blocks, it could notify the other modules to discard or forward the packet and it could also stop performing destination address comparison in subsequent collection and comparison operations (i.e., the source address comparison is continued). Then, when it finds a record at a block's address 88 matching the packet's source address, the search/comparison device 200 could directly update the content of the record such as modifying the time stamp field. Please note that, if the addressing device continues to generate address signals and all blocks actively output records, such a record modification requires the arbitration of the blocks to avoid conflicts. In some embodiments of the present invention, the addressing device 300 is allowed to complete the full cycle. In some other embodiments, on the other hand, the search/comparison device 200 could issue another signal to the addressing device 300 to stop it from generating the subsequent address signals.

For every search/comparison device 200, if it could not find a record matching the destination address within the 128 collection and comparison operations, the packet is forwarded to all network ports except the packet's incoming port. If it could not find a record matching the source address within the 128 collection and comparison operations, this means a new computing device has joined the LAN and a record for this computing device has to be added into the lookup table. Since during the 128 collection and comparison operations, the search/comparison device 200 has already known which records within which blocks are empty based on the records' control bit field, the search/comparison device 200 could add relevant information into an empty record via the blocks' arbitration.

As the present invention adopts massive parallelism, it is very possible that two or more search/comparison device 200 would write into a same empty record. There are various ways to resolve such conflicts. For example, a priority order could be assigned to the network ports so that network port P0 has precedence over network port P1, network port P1 has precedence over network port P2, and so on. Therefore, when the search/comparison device 200 of network port Pk would like to write into an empty record, it would first make sure that network port P0, P1 . . . and Pk-1 are not writing into the same record. More details about this and other conflict resolutions are omitted here. However, from the foregoing description, it could be seen that all 256 records in the lookup table could be used and there is not space waste problem as often found in hashing.

The foregoing description does not provide detailed information about how search/comparison device 200 and addressing device 300 are implemented, as they are actually quite straightforward to those skilled in the related arts. For example, the addressing device is mainly a counter, while the search/comparison devices 200 might contain multiple registers for holding the records output from each block. On the other hand, the search/comparison device 200 could perform linear search (implemented in firmware or hardware) to the records held in these registers. In addition, in some embodiments, the interface circuit of a network port is integrated with its corresponding search/comparison device 200, instead of being two separate circuits.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A lookup table circuit structure used in a layer 2 and above network switch device having M (M>1) network ports; said network switch device connecting at most M network segments via said M network ports; said circuit structure of said network switch device using a source address contained in a packet received from said network ports to store relevant information about a computing device at said source address into a record of a lookup table; said circuit structure of said network switch device using a destination address contained in a packet received from said network ports to search said lookup table to locate a record containing information about a computing device at said destination address; and said circuit structure comprising:
M search/comparison devices, each of which is connected to an interface circuit of a corresponding network port, receives a packet passed to it from said corresponding network port when said packet arrives at said network port, searches said lookup table, and notify a search result to a processing module of said network switch device so as to conduct a disposition to said packet;
N (N≧1) blocks jointly forming said lookup table, each of which contains L (L≧1) records, connects to said M search/comparison devices in parallel via a connection mechanism so that a record within a block is output to said M search/comparison devices simultaneously; and
an addressing device, which connects to said M search/comparison devices in parallel so as to receive a search signal issued from said search/comparison devices, connects to said N blocks in parallel so as to output an address signal to said N blocks in parallel;
wherein a search/comparison device issues a search signal to said addressing device when said search/comparison device receives a packet from its corresponding network port; said addressing device sequentially generates and delivers L address signals (0 to L−1) simultaneously to said N blocks in parallel after said addressing device receives a search signal from a search/comparison device; each of said N blocks outputs the content of an addressed record within its block simultaneously to said M search/comparison devices in parallel, so that a search/comparison device completes a search of said lookup table always within the time required by said addressing device to generate L address signals; and, when another search signal arrives while said addressing device is generating an address signal K (0≦K≦L−1) in a cycle of generating L address signals, said addressing device records said address K and continues to generate address signals until said cycle is completed and then again from address 0 up to said address signal K.

2. The circuit structure as claimed in claim 1, wherein each record of said lookup table comprises a field for holding a computing device's address and a field for holding an ID of a network port to which said computing device's residential network segment is connected.

3. The circuit structure as claimed in claim 2, wherein each record of said lookup table further comprises a field for indicating whether the record is used and a field for indicating how long the record is used but not accessed in said lookup table.

4. The circuit structure as claimed in claim 1, wherein said source address and said destination address are MAC addresses.

5. The circuit structure as claimed in claim 1, wherein said disposition of a packet is one of the following actions: discarding said packet and forwarding said packet to at least a network segment via said network ports.

6. The circuit structure as claimed in claim 5, wherein said disposition of a packet further comprises an action of storing a source address of said packet and said packet's incoming port number into a record of said lookup table.

7. The circuit structure as claimed in claim 1, wherein searching and comparing records of said lookup table is implemented in firmware.

8. The circuit structure as claimed in claim 1, wherein searching and comparing records of said lookup table is implemented in hardware.

9. The circuit structure as claimed in claim 1, wherein said search/comparison device is an integral part of an interface circuit of a corresponding network port.
